(19) United States
(12) Patent Application Publication
(10) Pub. No.: US 2017/0242416 A1
(43) Pub. Date: Aug. 24, 2017

(54) CONTROL CIRCUIT SYSTEM AND METHOD FOR THE OPERATION THEREOF

(71) Applicant: Airbus Defence and Space GmbH, Taufkirchen (DE)

(72) Inventors: Rafael Knobling, Muenchen (DE); Karin Bauer, Oberhaching (DE); Winfried Kupke, Ottobrunn (DE)

(73) Assignee: Airbus Defence and Space GmbH, Taufkirchen (DE)

(21) Appl. No.: 15/434,450

(22) Filed: Feb. 16, 2017

(30) Foreign Application Priority Data
Feb. 22, 2016 (EP) 16156703.7

(51) Int. Cl. G05B 19/048; H02J 13/00

(52) U.S. Cl. CPC G05B 19/048; H02J 13/00; G05B 2219/25257

(57) ABSTRACT

A control circuit system for influencing at least one process variable includes a plurality of sensors which each detect at least one measurement variable, a plurality of actuators which each manipulate at least one control variable, wherein the sensors and actuators are each assigned electronic circuits for control, and at least one control mechanism which controls and/or coordinates each of the plurality of sensors and actuators by means of at least one control unit. The control circuit system is sub-divided into a plurality of sub-units which are each provided with at least one sensor, at least one actuator and at least one control unit, and for a plurality of the sub-units, in particular all of the sub-units, each to be set up to operate a control circuit system.

### FIELD OF THE INVENTION

The invention relates to a control circuit system for influencing at least one process variable, comprising a plurality of sensors which each detect at least one measurement variable, comprising a plurality of actuators which each manipulate at least one control variable, the sensors and actuators each being assigned electronic circuits for control, and comprising at least one control means which controls and/or coordinates each of the plurality of sensors and actuators by means of at least one control unit. The invention further relates to a method for operating a control circuit system of this type.

### BACKGROUND OF THE INVENTION

Existing control circuit systems, in particular sensor/actuator-based systems used in air travel, are specialised either for a particular type of control circuits for a specific problem or for the hierarchical application of a plurality of sub-units in an overall system.

### BRIEF SUMMARY OF THE INVENTION

One idea of the present invention is to increase reliability and load capacity, reduce general complexity, and facilitate maintenance in a controlled system comprising a plurality of sensors and actuators, as used for flow control.

A control circuit system of the aforementioned type in which the control circuit system is subdivided into a plurality of sub-units which are each provided with at least one sensor, at least one actuator and at least one control unit, and in that a plurality of the sub-units, in particular all of the sub-units, are each set up to operate a control circuit system.

In the control circuit system according to an embodiment of the invention, a flat hierarchy of equally important control circuit units from which the complete system is built is established. In this way, the dependence on a central control unit is reduced, but moreover simpler scaling and maintenance for air travel applications are also achieved. The aforementioned control circuit units are formed by the sub-units, which can themselves take over tasks of a control circuit in part or in whole and in the process in particular manipulate one or more other sub-units, for example in that the parameter set thereof is adapted. Generally, the sensors will detect an identical measurement variable, for example a flow speed, but it is also conceivable for different measurement variables to be detected by different sensors. Equally, of course, different control variables may also be manipulated by the plurality of actuators.

The sub-units are given the possibility of operating autonomously, but in a coordinated manner. If a sub-unit of the system suffers from a malfunction, the functionality thereof can be taken over by the adjacent sub-systems. This leads to more flexibility and load capacity in application as a result of local autonomy and the establishment of a cooperative multi-agent system.

An advantageous embodiment of the control circuit system may consist in distributing all sensors, actuators and control units of the control circuit system among sub-units, in such a way that the control circuit system in question is entirely formed by a plurality of substantially autonomous sub-units. However, it is also conceivable for only some of the sensors and actuators comprising control units to be subdivided into sub-units, whilst for example particular sensors and actuators which are not directly adjacent, for example being physically spaced apart regularly or irregularly, remain controllable by a type of central control unit of the control means. Depending on the point of view, however, this may also be considered a sub-unit of the control circuit system.

The control circuit system according to an embodiment of the invention becomes particularly flexible if all of the sub-units are configured identically.

In order to detect a measurement variable of the relevant system, for example a measurement variable for evaluating a flow, such as a flow speed, an advantageous embodiment of the control circuit system may be provided with a plurality of identical sub-units, which are arranged in particular in the manner of a two- or three-dimensional matrix, in such a way that the local relationships of the measurement variable can be effectively detected in a plane or in space and can subsequently be manipulated.

Good spatial resolution of the measurement variable can be achieved for example by means of an expedient development of the control circuit system according to an embodiment of the invention in which a sub-unit comprising two sensors, an actuator and a control unit is provided. Advantageously, the actuator may be arranged physically between the two sensors, in such a way that the change in the measurement variable over the cross section of the sub-unit makes it possible to predict either the development thereof over time or the effect of actuating the actuator, downstream of which the second sensor is positioned. For this purpose, the sub-unit may preferably be arranged in such a way that a flow initially flows over the first sensor and subsequently flows over the second sensor. Moreover, for this purpose, in a preferred development, each sub-unit may comprise at least one sensor/actuator arrangement, which forms a planar, plate-like arrangement, in such a way that the plurality of sub-units can again be arranged two- or three-dimensionally without this arrangement necessarily having to be regular.

So as to be able to control the detection of measurement values by the sensors and the actuation of the actuators, whilst also being able to provide autonomy of the sub-units and the takeover of functionalities of other sub-units if they fail, in another embodiment of the control circuit system each control unit of the control means on a sub-unit is provided with at least one microcontroller. Taking over functionalities of for example one or more adjacent sub-units may consist in completely replacing them or adapting the control parameters of adjacent components. However, other takeover measures are conceivable; for example, it is possible to switch parts on and off without external intervention via control by means of one sub-unit in the system. This may take place on the basis of load capacity considerations (for example so as to place less strain on components) or according to varying ambient conditions, such as the flow conditions, determined by means of the sensors. Further, it is also conceivable for the sub-unit merely to adapt its own sensor/actuator model parameters so as to replace and compensate for the functionality of a completely faulty unit. Depending on the type of error occurring, by way of the combination of sub-units and the manner of communication, an adaptation may also relate to the data flow or relate to control being taken over by components shared with the faulty sub-unit.

In advantageous embodiments of the control circuit system, the microcontroller may initially, so as to perform the tasks thereof, have at least one control member and at least one connection to an external communication path, in such a way that the control can be taken over and communication with other units of the control circuit system is possible. In further advantageous embodiments, the relevant microcontroller may comprise at least one detection and control member for the at least one associated sensor and/or comprise a calculation and control member for the at least one associated actuator and/or comprise a plausibility check member.

By using an appropriate communication channel, which makes it possible for the units to intercommunicate, the units can recognise the status of the other units in the vicinity thereof. If a unit fails or exhibits behaviour outside the specifications thereof, at least the adjacent units should be informed in such a way that they can react. So as to be able to provide effective communication between the intercommunicating sub-units of the control circuit system according to the invention, a development provides for the communication path, on which a control unit is connected via the microcontroller thereof to the control circuit system in each case, to be formed by a bus, in particular a field bus, in such a way that the data transfer between the sub-units is taken over by a unitary communication layer, a protocol, which is independent of the individual transmitter and receiver. So as to be able to link the sensors and actuators of the sub-units into the communication in a simple manner, in a development the bus is expediently formed by a PROFIBUS system, an Interbus system, an ASI system, a PROFINET system, an EtherCAT system or a wireless transmission system. The suitability of other buses is not limited by the above list.

So as to make it possible for the control circuit system to be able to react flexibly to failures of one or more sub-units, the sub-units must be able to intercommunicate in a suitable manner with as much redundancy as possible. For this purpose, in a further embodiment of the control circuit system, the sub-units communicate via the communication path using a protocol which comprises information about the status of each of the sub-units at least at the relevant communication time.

The communication between the sub-units is topologically organised in a manner which makes multiple signal paths possible. This ensures a situation where failure in a particular path does not block the spread of information throughout the system. Expediently, the sub-units can be or are synchronised with one another via the protocol used, in such a way that intercommunicating sub-units detect, from a type of time stamp, what time a status report for a sub-unit relates to.

If one or more sub-units malfunction, other sub-units or the control units thereof are intended to take over the functionalities of the faulty system, by replacing it or by adapting the control parameters of adjacent components so as to compensate for the effects of the missing sub-unit.

For this purpose, in a further embodiment of the control circuit system, each of the sub-units may be provided with a checking protocol, which reacts to a change in the status information of at least one other sub-unit and adapts control parameters implemented on the other sub-unit in question accordingly. Thus, a control unit may for example be provided merely to react to malfunctions of adjacent sub-units and to negotiate a parameter change with the shared adjacent sub-units. In another advantageous development, which has advantages in particular as regards the ability to scale to a large number of units, each of the sub-units may be set up to detect failure of at least one adjacent sub-unit, in particular of each sub-unit of the control circuit system. Since the sub-units each control the status of the other sub-units, a type of health monitoring protocol for the overall system is run on each sub-unit, and reacts to a change in status of other sub-units and can adapt the system control parameters thereof accordingly. Moreover, failure of the unit can be communicated by way of the absence of the protocol update or by way of some other type of marker.

An aspect of the invention includes a method for operating a control circuit system for influencing at least one process variable in which the control circuit system is subdivided into a plurality of sub-units which are each provided with at least one sensor, one actuator and one control unit, and in that a plurality of the sub-units, in particular all of the sub-units, are each set up to operate an independent control circuit system.

The above embodiments and developments may be combined with one another in any desired manner within reason. Further possible embodiments, developments and implementations of the invention also include combinations not explicitly mentioned of features of the invention disclosed above or in the following in relation to the embodiments. In particular, a person skilled in the art will also add individual aspects to each basic form of the present invention as improvements or additions.

### BRIEF DESCRIPTION OF THE DRAWINGS

The present invention is described in greater detail in the following by way of the embodiments set out in the drawings, in which, in a schematic representation in part:

FIG. 1 is a schematic drawing of a first embodiment of a control circuit system according to the invention comprising a plurality of sub-units which are each provided with an actuator and two sensors;

FIG. 2 is a schematic drawing of a sub-unit of a further embodiment of the control circuit system including a detailed drawing of the control unit; and

FIG. 3a, b are two schematic drawings showing different communication paths which can be established between the sub-units, each unit communicating with every other sub-unit via a main bus in one case (FIG. 3a), whilst in the other case communication is only permitted between adjacent sub-units (FIG. 3b).

In all the drawings, like or functionally like elements and devices have been provided with the same reference numerals unless specified otherwise.

### DETAILED DESCRIPTION

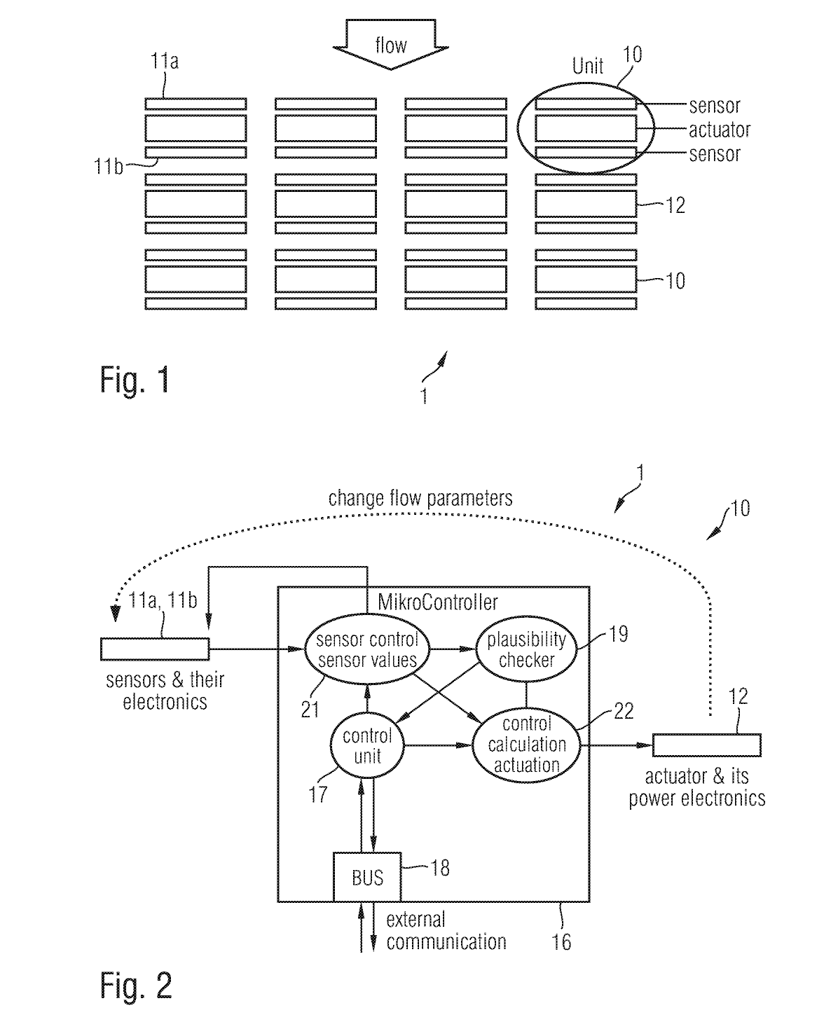

By way of example, FIG. 1 shows a control circuit system denoted as 1 as a whole and comprising a plurality of sensors and actuators, in which each sub-unit 10 is defined by two sensors 11a, 11b and an actuator 12, the control units 20 of the sub-units 10 having been omitted in this drawing for improved clarity. The flow represented by the arrow 5 flows over the control circuit system 1 at the sub-units 10 thereof, and over these in turn at the first sensors 11a thereof, and a flow status represented by a measurement variable is measured. A flow status varied by actuating the actuator 12 may subsequently be detected by way of the second sensor 11b assigned to the sub-unit 10 in question.

In this regard, FIG. 2 shows the main components of the sub-units 10 of a control circuit system 1. On the left side of the drawing as seen by the viewer, initially the sensors 11a, 11b and the electronic control circuits can be seen, in the centre the control unit 20, formed by a microcontroller 16, and the control members and communication means thereof can be seen, and on the right side of the drawing as seen by the viewer, finally the actual actuator 12 along with the required power supply thereof and the control electronics thereof can be seen. In the present drawing, the microcontroller is provided with a detection and control member 21 for the associated sensors 11a, 11b, by means of which a signal exchange takes place. Further, a control member 17 for the general calculations and coordination of the actions thereof with other sub-units 10 and at least one connection 18 to an external communication path can be seen. Finally, the microcontroller 16 of the control unit 20 is provided with a calculation and control member 22 for the associated actuator 12, and comprises a plausibility check member 19.

FIG. 2 shows that a sub-unit 10 may be much more complex than might initially be supposed from FIG. 1. Specifically, in FIG. 2 an input signal is received at the sensor 11a, 11b in real time by the detection and control member 21 of the microcontroller 16, and the microcontroller 16 subsequently determines the flow status on the basis of the sensor information and, if required by the sensor circuit, establishes the sensor control. The flow status information is subsequently passed to the control calculation algorithm of the with a calculation and control member 22 of the actuator 12 and to a plausibility check by the plausibility check member 19, which searches for signs of a fault. The control algorithm subsequently determines the most favourable acceptable type and the minimum strength of the output signal for the actuator 12 so as to supply the flow which is favourable in the given situation. The control member 17, as a main component of the control unit 20 or of the microcontroller 16 thereof, can modify the parameters within the sensor/actuator model (for example by introducing a damping or weighting parameter).

If the sensors 11a, 11b require their own control calculation circuit, this can also be established by means of the microcontroller 16. The sensor data and the control performance are thus checked at least at regular intervals, if not continuously, by the plausibility check member 19, which gives feedback on the status of the sub-unit 10. The communication with other units 10 subsequently takes place by means of the control unit 16 via a bus and an appropriate protocol, which also contains the status of each sensor 11a, 11b.

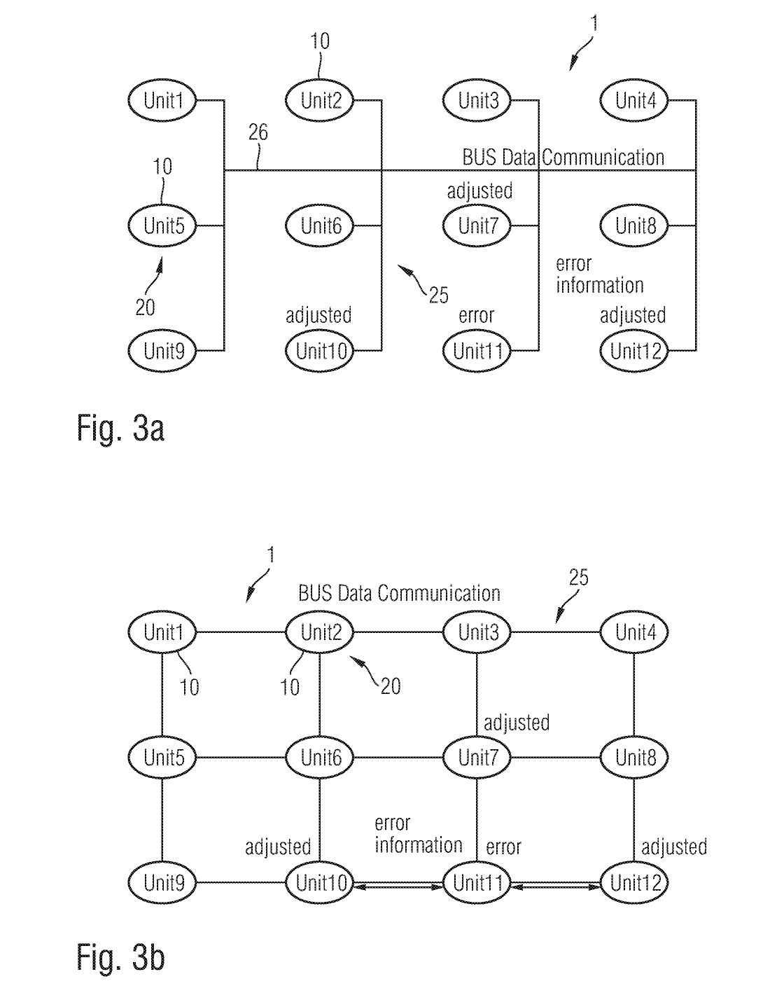

FIG. 3a, 3b show different implementations of the communication bus for communication between the control units 20 of the sub-units 10. In the upper diagram, there is a main bus 26, whilst the protocol contains the complete status information. If a sub-unit 10 fails, in the upper diagram of FIG. 3a for example the unit having serial number 11, this information is made available to all other sub-units, but only the sub-units 10 having serial numbers 7, 10, 12 are involved in adaptations.

In FIG. 3a, all sub-units 10 are connected by a shared bus 25. If a sub-unit 10 exhibits faulty behaviour, such as the unit having serial number 11 in this case, the model of the other sub-units 10 can be adapted. Thus, in the present example, for instance, the unit having serial number 7 requires a stronger output signal so as to increase the effect of the cooperation with the unit having serial number 3. The sub-units 10 having serial numbers 10 and 12 and also other sub-units 10 may also be adapted to the present flow independently of the actuator 12 and the type of the present flow. If the bus 25 requires a master for temporally synchronising all of the sub-units 10, this may be determined randomly from among all of the sub-units 10. If the maser subsequently enters an error state, another random unit 10 can take over.

The lower diagram of FIG. 3b shows another approach, in which only bus communication with adjacent components is possible, and if for example the sub-unit 11 fails only the surrounding sub-units are aware of this and take counter-measures. The implementation of FIG. 3b accordingly shows a bus 25 in which only adjacent sensors communicate with one another.

Although the present invention was disclosed in the above by way of preferred embodiments, it is not limited thereto, but can be modified in various manners. In particular, the invention can be varied or modified in a range of ways without departing from the central concept of the invention.

This is because the concept of independent sub-units 10 comprising a sensor/actuator/microcontroller combination can be extended to numerous other applications, such as structural measurements, and is therefore not limited to flow control applications.

The concept makes it possible to replace individual faulty sub-units 10 in a simple manner during maintenance, and the extension to a larger number of sub-units 10 is merely limited by the type of bus 25. Increasing the number of sub-units 10 can also increase the general reliability of a system 1; the design proposed in the present invention therefore increases the load capacity of a system 1 in various ways, and is therefore very promising for applications of control systems comprising a plurality of components which can be subdivided into sub-units 10 which are similar to one another.

Accordingly, the invention disclosed herein relates to a control circuit system 1 for influencing at least one process variable, comprising a plurality of sensors 11a, 11b, which each detect at least one measurement variable, comprising a plurality of actuators 12, which each manipulate at least one control variable, the sensors 11a, 11b and actuators 12 each being assigned electronic circuits for control, and comprising at least one control means, which controls and/or coordinates each of the plurality of sensors 11a, 11b and actuators 12 by means of at least one control unit 20. So as to increase reliability and load capacity, reduce general complexity, and facilitate maintenance in a controlled system comprising a plurality of sensors 11a, 11b and actuators 12, as used for flow control, it is proposed to subdivide the control circuit system 1 into a plurality of sub-units 10 which are each provided with at least one sensor 11a, 11b, at least one actuator 12 and at least one control unit 20, and for a plurality of the sub-units 10, in particular all of the sub-units 10, each to be set up to operate a control circuit system 1.

The overall reliability of the system 1 is increased by identical sub-units 10 which can be adapted freely in view of the status of the overall system 1. For flow control, each sub-unit 10 may be adjusted locally in accordance with the prevailing flow conditions of the input flow and the status of the status of the surrounding sub-units 10 in the vicinity thereof. Further, maintenance and repair for a system 1 consisting of the same sub-units 10 can be reduced, since broken sub-units 10 can be replaced as a unit. Moreover, it is simpler to construct the system 1 with a view to a larger active network for flow control, since in this case there are no limitations as regards a central control unit, but only as regards the capabilities for bus communication of the implemented protocol. Not least, self-testing and self-monitoring properties are implemented by way of the network communication, the inventive principle being applicable to many other control circuit applications aside from flow control.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A control circuit system for influencing at least one process variable, comprising:
a plurality of sensors each detecting at least one measurement variable;
a plurality of actuators each manipulating at least one control variable;
the sensors and actuators being each assigned electronic circuits for control; and
at least one control means controlling and/or coordinating each of the plurality of sensors and actuators by at least one control unit, the control circuit system being subdivided into a plurality of sub-units which are each provided with at least one sensor, at least one actuator and at least one control unit, a plurality of the sub-units being each set up to operate a control circuit system.

2. The control circuit system of claim 1, wherein all the sensors, actuators and control units of the control circuit system are distributed among sub-units.

3. The control circuit system of claim 1, wherein the control circuit system is provided with a plurality of identical sub-units, which are arranged in the manner of a two- or three-dimensional matrix.

4. The control circuit system of claim 1, wherein a sub-unit is provided with two sensors, an actuator and a control unit.

5. The control circuit system of claim 1, wherein each sub-unit comprises at least one sensor/actuator arrangement, which forms a planar, plate-like arrangement.

6. The control circuit system of claim 1, wherein each control unit of the control means is provided with at least one microcontroller.

7. The control circuit system of claim 6, wherein the microcontroller comprises at least one control member and at least one connection to an external communication path.

8. The control circuit system of claim 6, wherein the microcontroller comprises at least one of:
at least one detection and control member for the at least one associated sensor;
a calculation and control member for the at least one associated actuator; and
at least one plausibility check member.

9. The control circuit system of claim 7, wherein the communication path on which each control unit is or can be connected via the microcontroller thereof to the control circuit system, is formed by a bus.

10. The control circuit system of claim 9, wherein the bus is formed by a PROFIBUS system, an Interbus system, an ASI system, a PROFINET system, an EtherCAT system or a wireless transmission system.

11. The control circuit system of claim 1, wherein that the sub-units communicate via the communication path by a protocol which comprises information as to the status of each of the sub-units at least at the relevant communication time.

12. The control circuit system of claim 1, wherein every two sub-units intercommunicate via a plurality of communication paths and/or the sub-units are synchronisable or synchronised with one another by way of the protocol used.

13. The control circuit system of claim 1, wherein each of the sub-units is provided with a checking protocol, which reacts to a change in the status information of at least one other sub-unit and adapts control parameters implemented on the other sub-unit in question accordingly.

14. The control circuit system of claim 1, wherein each of the sub-units is set up to detect failure of at least one adjacent sub-unit.
